(19) United States
(12) Patent Application Publication
(10) Pub. No.: US 2008/0238299 A1
(43) Pub. Date: Oct. 2, 2008

(54) NANODOT ELECTROLUMINESCENT DIODE OF TANDEM STRUCTURE AND METHOD FOR FABRICATING THE SAME

(75) Inventors: Kyung Sang CHO, Gwacheon-si (KR); Byoung Lyong CHOI, Seoul (KR); Soon Jae KWON, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/017,677

(22) Filed: Jan. 22, 2008

(30) Foreign Application Priority Data
Jan. 22, 2007 (KR) 10-2007-0006725

(51) Int. Cl. H01J 1/62

(52) U.S. Cl. 313/503

(57) ABSTRACT

A nanodot electroluminescent diode is disclosed. The nanodot electroluminescent diode comprises a lower electrode, an upper electrode, and unit cells interposed between the electrodes, wherein the unit cells comprise a quantum dot electroluminescent layer and also include an organic layer and/or an inorganic layer in addition to the quantum dot electroluminescent layer. The disclosed nanodot electroluminescent diode provides high efficiency, stability, and high luminance, and mixed colors, multi-colors, full color, and white electroluminescence can be obtained.

### CROSS-REFERENCE TO RELATED APPLICATIONS

This application claims priority to Korean Patent Application No. 10-2007-0006725, filed on Jan. 22, 2007, and all the benefits accruing therefrom under 35 U.S.C. § 119, the contents of which are herein incorporated by reference in its entirety.

### BACKGROUND OF THE INVENTION

1. Field of the Invention

The disclosed embodiments relate to a nanodot electroluminescent diode and a method for fabricating the nanodot electroluminescent diode to obtain high efficiency, stability, multiple colors, and high luminance.

2. Description of the Related Art

A quantum dot is a nanocrystal of a metal or a semiconductor having a size smaller than a Bohr exciton radius, i.e., several nanometers. Although a large number of electrons can exist within a quantum dot, the number of free electrons is finite, thus the number of free electrons can be in an amount of 1 to about 100. In this case, since the electron energy levels are discontinuous, electrical and optical properties are different from those of a bulk metal or semiconductor. In bulk materials there are a large number of electrons, thus energy levels, form effectively a continuous energy band. Since the energy level of a quantum dot depends on its size, its band gap can be selected by selection of the size of the quantum dot.

Such new properties of the quantum dot enable optomagnetic, thermoelectric, and electromagnetic functions that are not possible with bulk materials. Specifically, the quantum dot can be used in various fields, such as information storage, photovoltaics, bio-molecule labeling, or to fabricate a single electron diode or a light-emitting diode (LED).

Despite effort on application of quantum dots as a light-emitting layer in LEDs, problems with efficiency, luminance, and arrangement of mixed colors persist.

### SUMMARY

Disclosed is a multiple nanodot electroluminescent diode, and a method for fabricating the multiple nanodot electroluminescent diode, in which a plurality of unit cells, each of which includes a quantum dot electroluminescent layer and an organic layer and/or an inorganic layer, are interposed between a lower electrode and an upper electrode to obtain high efficiency, stability, multi-colors, and high luminance.

Disclosed herein too is a multiple nanodot electroluminescent diode, and a method for fabricating the multiple nanodot electroluminescent diode, in which a quantum dot electroluminescent layer which can luminesce in various colors is applied to a plurality of unit cells, the unit cells interposed between a lower electrode and an upper electrode, to obtain mixed colors, multi-colors, full color, or white electroluminescence.

Also disclosed in an embodiment is a multiple nanodot electroluminescent diode that comprises a lower electrode, an upper electrode, and unit cells interposed between the electrodes, wherein each unit cell includes a quantum dot electroluminescent layer and also includes an organic layer and/or an inorganic layer in addition to the quantum dot electroluminescent layer, and the unit cells are interposed between the lower electrode and the upper electrode. The number of the unit cells can be selected to accommodate the particular application. The maximum number of the unit cells is 100. Specifically, the number of the unit cells is in an amount of up to about 50, specifically up to about 20, more specifically up to about 10, more specifically still up to about 3.

The organic layer and/or the inorganic layer of the unit cells can be a hole injection layer or a hole transport layer. Also, the organic layer and/or the inorganic layer of the unit cells can be an electron injection layer or an electron transport layer. Also, the respective layers can constitute a single layer or a plurality of layers. For example, the hole injection layer can be disposed in a manner so as to constitute a double layer or a triple layer.

The unit cells further include an electrode layer.

The quantum dot electroluminescent layer comprises a compound semiconductor nanocrystals, which is comprised of elements from groups II and VI, groups III and V, groups IV and VI, or group IV, where the groups refer to the respective groups of elements in the periodic table of the elements. Such materials are referred to as a group II-VI compound semiconductor, a group III-V compound semiconductor, a group IV-VI compound semiconductor, or a group IV compound semiconductor, respectively. In addition, these materials can have nanocrystalline morphology, thus can be referred to as nanocrystals.

Exemplary compound semiconductor nanocrystal materials include group II-VI compound semiconductor nanocrystal materials, which include binary compounds, such as CdSe, CdTe, ZnS, ZnSe, ZnTe, or the like, ternary compounds, such as CdSeS, CdSeTe, CdSTe, ZnSeS, ZnSeTe, ZnSTe, CdZnS, CdZnSe, CdZnTe, or the like, quaternary compounds, including CdZnSeS, CdZnSeTe, CdZnSTe, CdHgSeS, CdHgSeTe, CdHgSTe, HgZnSeS, HgZnSeTe, HgZnSTe, or the like, and combinations comprising at least one of the foregoing compounds.

In addition, exemplary compound semiconductor nanocrystal materials can comprise group III-V compound semiconductor nanocrystal materials, including binary compounds, including GaN, GaP, GaAs, GaSb, InP, InAs, InSb, or the like, ternary compounds, including GaNP, GaNAs, GaNSb, GaPAs, GaPSbInNP, InNAs, InNSb, InPAs, InPSb, GaAlNP, or the like, and quaternary compounds, including GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, or the like, or combinations comprising at least one of the foregoing compounds.

In addition, compound semiconductor nanocrystal materials can comprise group IV-VI compound semiconductor nanocrystal materials, including binary compounds, including PbS, PbSe, PbTe, or the like, ternary compounds, including PbSeS, PbSeTe, PbSTe, SnPbS, SnPbSe, SnPbTe, or the like, and quaternary compounds including SnPbSSe, SnPbSeTe, SnPbSTe, or the like, or combinations comprising at least one of the foregoing compounds.

Also, compound semiconductor nanocrystal materials can comprise group VI compound semiconductor nanocrystal materials, including an element, including Si and Ge, and binary compounds including SiC, SiGe, or the like, or combinations comprising at least one of the foregoing compounds.

Furthermore, materials can comprise a core/shell structures, where the shell comprises of a wide-band gap semiconductor nanocrystal material, such as CdSe/ZnS, CdSe/ZnSe, CdTe/ZnS, CdTe/ZnSe, CdSe/CdS, CdS/ZnS, CdS/ZeSe, InP/ZnS, PbSe/ZnS, or the like, or combinations comprising at least one of the foregoing materials, can be used as semiconductor nanocrystals.

The quantum dot electroluminescent layer included within each unit cell can luminesce in the same color for each unit cell, or the quantum dot electroluminescent layers included within the unit cells can luminesce in different colors for each unit cell.

The quantum dot electroluminescent layer included in each unit cell can have the same configuration as that of an organic layer and an inorganic layer. Alternatively, the quantum dot electroluminescent layer included in each unit cell can have a configuration different from that of an organic layer and an inorganic layer.

### BRIEF DESCRIPTION OF THE DRAWINGS

The foregoing and other disclosed embodiments are apparent from the following detailed description, taken in conjunction with the accompanying drawings in which:

FIG. 1 illustrates an exemplary multiple nanodot electroluminescent diode according to an exemplary embodiment;

FIG. 2 illustrates an exemplary multiple nanodot electroluminescent diode according to an alternative exemplary embodiment;

FIG. 3 illustrates an exemplary multiple nanodot electroluminescent diode according to an alternative exemplary embodiment;

FIG. 4 is a chromaticity diagram (CIE diagram) of an exemplary multiple nanodot electroluminescent diode where two unit cells, each of which comprise a red quantum dot electroluminescent layer, are disposed in accordance with a first exemplary embodiment;

FIGS. 5A to 5C illustrate current-voltage, luminance variation according to voltage, and efficiency variation according to voltage properties of a single nanodot electroluminescent diode where one unit cell is interposed between a lower electrode and an upper electrode in accordance with an exemplary embodiment;

FIGS. 6A to 6C illustrate current-voltage, luminance variation according to voltage, and efficiency variation according to voltage properties of a multiple nanodot electroluminescent diode where two unit cells are disposed in accordance with an exemplary embodiment;

FIG. 7 is an electroluminescence (EL) spectrum of an exemplary nanodot electroluminescent diode where one unit cell is interposed between a lower electrode and an upper electrode in accordance with an exemplary embodiment; and

FIG. 8 is an electroluminescence (EL) spectrum of an exemplary multiple nanodot electroluminescent diode where two unit cells are disposed in accordance with an exemplary embodiment.

The detailed description explains the disclosed embodiments, together with advantages and features, by way of example with reference to the drawings.

### DETAILED DESCRIPTION OF THE INVENTION

Reference will now be made in detail to the exemplary embodiments, which are illustrated in the accompanying drawings, wherein reference numerals of like elements are used consistently throughout this specification.

A method for forming a multiple nanodot electroluminescent diode according to an exemplary embodiment is described below.

A lower electrode is formed on a wafer, and then unit cells comprised of a quantum dot electroluminescent layer, an organic layer and/or an inorganic layer are formed on the quantum dot electroluminescent layer. In this case, the respective layers are disposed sequentially in accordance with a deposition order to form a first unit cell. After formation of the first unit cell, the layer formation processes are repeated to form the respective layers disposed sequentially in accordance with a deposition order to form a second unit cell. In this way, the first to nth unit cells are formed and the number of unit cells selected to accommodate the particular application. Then, an upper electrode is formed on the unit cells, to provide a multiple nanodot electroluminescent diode according to an exemplary embodiment.

A single or multiple nanodot electroluminescent diode according to an exemplary embodiment can be fabricated by a wet method or a dry method. When the wet method is used, a large sized diode can be obtained at a room temperature and at a room pressure, thus an encapsulation process is not used. Thus the diode can be fabricated at a reduced cost.

A method for fabricating a single or multiple nanodot electroluminescent diode using a wet method will be described below. First, a hole transport layer material, specifically a PEDOT[poly(3,4-ethylenedioxythiophene)] or PEDOT/PVK[(poly(vinylcarbazole))] thin film, is sequentially spin-coated on an indium tin oxide (ITO) wafer, dried and annealed times to form a hole transport layer. Next, a quantum dot electroluminescent layer solution is spin-coated on the hole transport layer, and cross-linked with a solution of a cross-linking agent in an organic solvent to cross-link the quantum dot electroluminescent layer. The quantum dot electroluminescent layer is then dried. (Cross-linking is such that even if the organic solvent is spin-coated on the quantum dot electroluminescent layer again after the quantum dot electroluminescent layer is cross-linked, the quantum dot electroluminescent layer is neither peeled off nor damaged.) An electron transport layer material, such as TiO₂ sol-gel precursor, is spin-coated on the cross-linked quantum dot electroluminescent layer and then annealed to form an electron transport layer, thereby forming a first unit cell. To form additional unit cells the above steps are repeated to form the second to nth unit cells. After the nth unit cell is formed, an upper electrode is disposed on the first unit cell to complete a single nanodot electroluminescent diode or on the nth unit cell to complete a multiple nanodot electroluminescent diode. In addition to the above described spin-coating processes, solution processes, such as a sol-gel methods, deep coating, casting, printing, and spraying can be used to fabricate the multiple nanodot electroluminescent diode. Also, regarding the processes for forming the electron transport layer and the hole transport layer, some or all of the disclosed wet processes can be replaced with dry processes, such as thermal evaporation, e-beam evaporation, sputtering, and vacuum deposition.

A lower electrode used for the single or multiple nanodot electroluminescent diode, according to an exemplary embodiment, can be an anode, and the anode material can be a conductive metal capable of hole injection, or its oxide. Exemplary lower electrode materials include indium tin oxide (ITO), indium zinc oxide (IZO), Ni, Pt, Au, Ag, Ir, or the like, or a combination comprising at least one of the foregoing materials.

An upper electrode can be a cathode, and the cathode material can be a metal having a low work function capable of electron injection, or its oxide. Exemplary materials for the upper electrode include indium tin oxide (ITO), Ca, Ba, Ca/Al, LiF/Ca, LiF/Al, BaF₂/Al, BaF₂/Ca/Al, Al, Mg, Ag-Mg alloy, or the like, or a combination comprising at least one of the foregoing materials. After the cathode is formed, an encapsulation process can be performed for its protection from the air. Then, the electroluminescent diode is finally completed.

In the multiple nanodot electroluminescent diode according to an exemplary embodiment, two or more unit cells are interposed in series between the lower electrode and the upper electrode. Each unit cell includes a quantum dot electroluminescent layer. In addition, each unit cell includes an organic layer (monomer and polymer) and/or an inorganic layer. Specifically, each unit cell comprises a single layer of each of a hole injection layer, a hole transporting layer, an electron transporting layer, and an electron injection layer. Alternatively, the unit cells can comprise a composite layer, where the composite layer is selected as one layer or combination of two or more layers to constitute the quantum dot electroluminescent layer a unit cell. Also, the unit cells can further include an electrode layer. In this case, the electrode layer serves to control the unit cells.

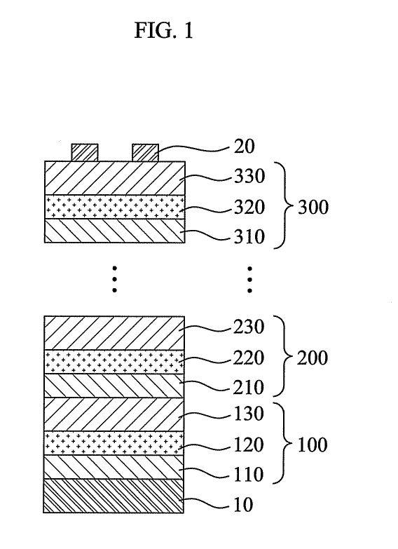

For example, as shown in FIG. 1, in a multiple nanodot electroluminescent diode according to an exemplary embodiment, a hole transport layer 110, a quantum dot electroluminescent layer 120, and an electron transport layer 130 constitute a first unit cell 100, while a hole transport layer 210, a quantum dot electroluminescent layer 220, and an electron transport layer 230 on the second unit cell constitute a second unit cell 200. Such unit cells are serially formed n times, where n represents an integer, to form first to nth unit cells between a lower electrode 10 and an upper electrode 20, wherein the nth unit cell 300 includes a hole transport layer 310, a quantum electroluminescent layer 320, and an electron transport layer 330.

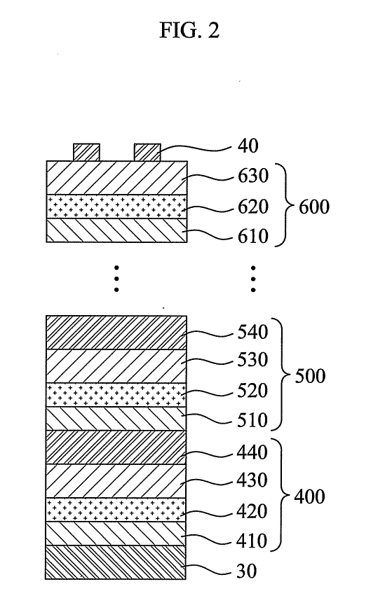

Furthermore, as shown in FIG. 2, in a multiple nanodot electroluminescent diode according to an exemplary embodiment, a second unit cell 500, comprised of a hole transport layer 510, a quantum dot electroluminescent layer 520, an electron transport layer 530, and an electrode layer 540, is formed on a first unit cell 400, where the first unit cell comprises a hole transport layer 410, a quantum dot electroluminescent layer 420, an electron transport layer 430, and an electrode layer 440. In this way, an nth unit cell 600, comprised of a hole transport layer 610, a quantum electroluminescent layer 620, and an electron transport layer 630, is formed. Thus, the first to nth unit cells can be formed sequentially so that they are interposed between a lower electrode 30 and an upper electrode 40.

In an embodiment, the unit cells interposed between the lower electrode and the upper electrode do not repeat the same unit cell structure. For example, the first unit cell can comprise of a hole injection layer, a hole transport layer, a quantum electroluminescent layer, and an electron transport layer, while the second unit cell can comprise of a hole transport layer, a quantum dot electroluminescent layer, and an electron transport layer. Similarly, a unit cell subsequently disposed can include a quantum electroluminescent layer, and can selectively include an organic layer and/or an inorganic layer to accommodate a particular application. Also, the layers of any given unit cell do not have to comprise the same materials or comprise layers in the same order as those of the other unit cells. Moreover, the quantum dot electroluminescent layer within each unit cell can emit blue, red, and/or green light to accommodate a particular application. The hole injection layer, the hole transport layer, the electron transport layer, and the electron injection layer can be used as a single layer or two or more layers within the unit cell. The number of the unit cells interposed between the lower electrode and the upper electrode can be selected considering the application, desired thickness, and the like.

In exemplary multiple nanodot electroluminescent diodes, hole transport materials can be used selectively within the unit cells. Exemplary materials for the hole transport layer include those derived from poly(3,4-ethylenedioxythiophene)/poly(styrene sulfonate) (PEDOT/PSS), poly-N-vinylcarbazole, polyphenylenevinylene, polyparaphenylene, polymethacrylate, poly(9,9-octylfluorene), poly(spiro-fluorene), TPD(N,N′-dephenyl-N,N′-bis(3-methylphenyl)-(1,1′-biphenyl)-4,4′-diamine), NPB(N,N′-di(naphthalene-1-yl)-N-N′-dipenyl-benzidine), m-MTDATA(tris(3-methylphenylphenylamino)-triphenylamine), TFB(poly(9,9′-dioctylfluorene-co-N-(4-buthylphenyl)diphenylamine)), a metal oxide such as NiO, a chalcogenide such as MoS₃, CdTe, or the like, or a combination comprising at least one of the foregoing materials.

In the multiple nanodot electroluminescent diode, exemplary electron transport layer materials include an oxide, such as TiO₂, ZnO, SiO₂, SnO₂, WO₃, Ta₂O₃, BaTiO₃, BaZrO₃, ZrO₂, HfO₂, Al₂O₃, Y₂O₃, ZrSiO₄, a nitride such as Si₃N₄, a semiconductor such as CdS, ZnSe or ZnS, an electron transport polymer, such as F8BT (poly-(2,7-(9,9′-di-n-octylfluorene-3,6-benzothiadiazole), or the like, or a combination comprising at least one of the foregoing materials. Specifically, the material of the electron transport layer is TiO₂, ZrO₂, HfO₂ or Si₃N₄.

In the multiple nanodot electroluminescent diode according to an exemplary embodiment, the hole injection layer material has no specific limitation. Specifically, a hole injection layer material having excellent interface properties is used, where the hole injection layer material can readily transfer an electron to an electrode. An exemplary hole injection layer material is poly(3,4-ethylenedioxythiophene) (PEDOT).

In the multiple nanodot electroluminescent diode according to an exemplary embodiment, the electron injection layer material has no specific limitation. An exemplary electron injection layer material is LiF.

In the multiple nanodot electroluminescent diode according to an exemplary embodiment, an opaque material, such as Al or Ag, can be used as an electrode material. Specifically, a metal having a low work function is used as the electrode material to facilitate electron injection into an organic layer and/or inorganic layer. However the electrode material has no specific limitation. A transparent conductive material can be used as the electrode material.

The disclosed multiple nanodot electroluminescent diode and the disclosed method for fabricating the multiple nanodot electroluminescent diode are embodiments and are not intended to limit the claims.

Hereinafter, the method for fabricating the multiple nanodot electroluminescent diode according to an exemplary embodiment is described with reference to the following embodiments. It is to be understood that the following embodiments are disclosed to assist understanding and are not intended to limit that claimed.

### EXAMPLE 1

A wafer, patterned with ITO, was washed sequentially with solvent such as a neutral detergent, deionized water, water, isopropylalcohol, or the like, or a combination of at least one of the foregoing solvents. The patterned wafer was then treated with UV-ozone. A PEDOT solution was then spin-coated on to the wafer for 30 seconds at 2000 revolutions per minute (rpm) to obtain a thin film having a thickness of about 50 nanometers (nm). Next, a 0.5 weight percent solution of PVK (poly(vinylcarbazole)) in chlorobenzene was spin-coated on to the wafer for 30 seconds at 2000 rpm to obtain a thin film having a thickness of 20 nm. The PVK coated wafer was then dried for 20 minutes in a vacuum. CdSe/ZnS core/shell nanocrystal (Evidot 630 nm absorbance, used as received commercially from Evident Technology, product name: Evidot Red(CdSe/ZnS) was spin-coated on the PVK film for 30 seconds at 2000 rpm and dried for 5 minutes at 50° C. to provide a quantum electroluminescent layer. The quantum electroluminescent layer coated wafer was then dipped in a 10 mM solution of 1,7-diaminoheptane in methanol (as a cross-linking agent) for 5 minutes, so that cross-linking occurred between quantum dots by the cross-linking agent. TiO₂ precursor sol (DuPont Tyzor, BTP, 5 weight percent in butanol) was spin-coated on the quantum dot thin film for 30 seconds at 2000 rpm. The TiO₂ precursor sol was dried for about 5 minutes and then annealed for 10 minutes at 70° C. to form an amorphous TiO₂ thin film of about 40 nm.

To form an electroluminescent layer of the second unit cell, thin films of a PEDOT (hole injection layer), PVK (hole transporting layer), a quantum dot electroluminescent layer, and a TiO₂ (electron transporting layer) were formed. The thin films were formed using the same process steps described above. The PEDOT layer of the second unit cell was dried for 5 minutes at 70° C. and then the film annealed in a glove box for 5 minutes at 150° C. After the PVK and quantum dot thin films were fabricated, the TiO₂ thin film of the second unit cell was formed by spin-coating and then annealed for 10 minutes at 100° C. Next, after an LiF thin film of 7Å was deposited using a patterned mask, an Al electrode was deposited at a thickness of about 200 nm. The quantum dot electroluminescent diode was then sealed in a glove box using an encapsulation glass to exclude oxygen and water. The quantum dot electroluminescent diode was then taken out of the glove box to measure the quantum dot electroluminescent diode's properties. The results of this experiment were obtained after LiF was deposited and the diode sealed in an encapsulation glass. The Al electrode can selectively be deposited without LiF deposition. In this case, electroluminescent luminance was reduced to ⅓, and sealing using the encapsulation glass not used.

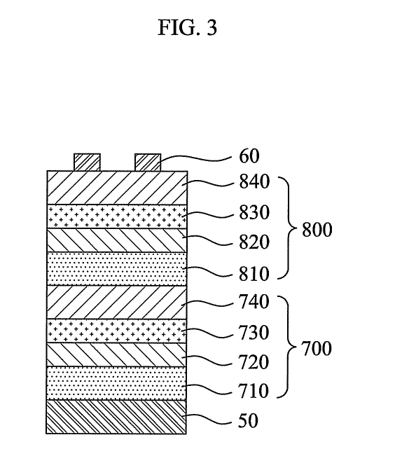

FIG. 3 illustrates a multiple structure of a multiple nanodot electroluminescent diode where two unit cells including a red quantum dot electroluminescent layer were deposited in accordance with Example 1. As shown in FIG. 3, the nanodot electroluminescent diode according to Example 1 constitutes a multiple structure where two unit cells, which comprise a first unit cell 700 and a second unit cell 800, are disposed between a lower electrode 50 and an upper electrode 60. The first unit cell 700 includes a PEDOT hole injection layer 710, a PVK hole transporting layer 720, a quantum dot electroluminescent layer 730, and a TiO₂ electron transporting layer 740 while the second unit cell 800 includes a PEDOT hole injection layer 810, a PVK hole transporting layer 820, a quantum dot electroluminescent layer 830, and a TiO₂ electron transporting layer 840.

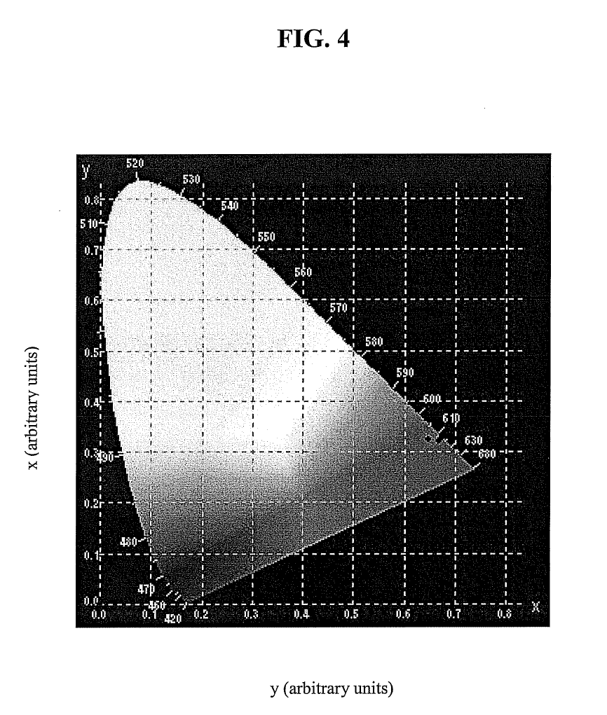

FIG. 4 is a chromaticity diagram (CIE) diagram of a multiple nanodot electroluminescent diode where two unit cells, which include a red quantum dot electroluminescent layer, are disposed in accordance with Example 1.

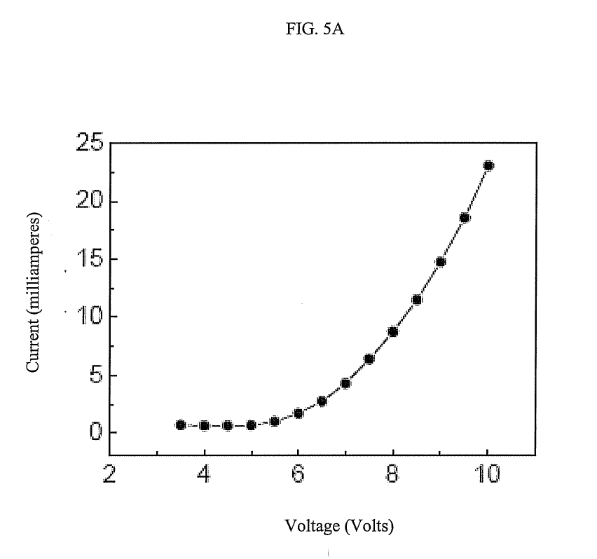

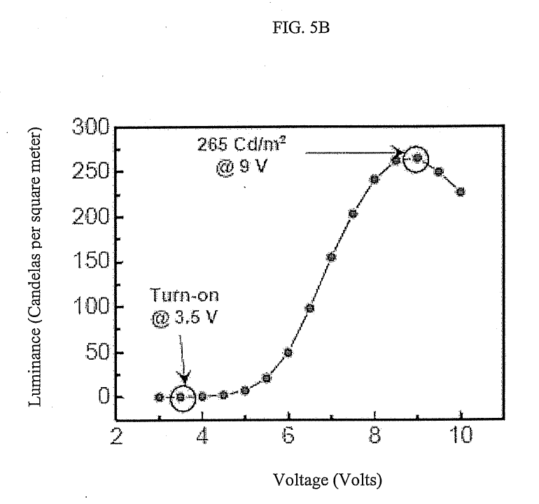

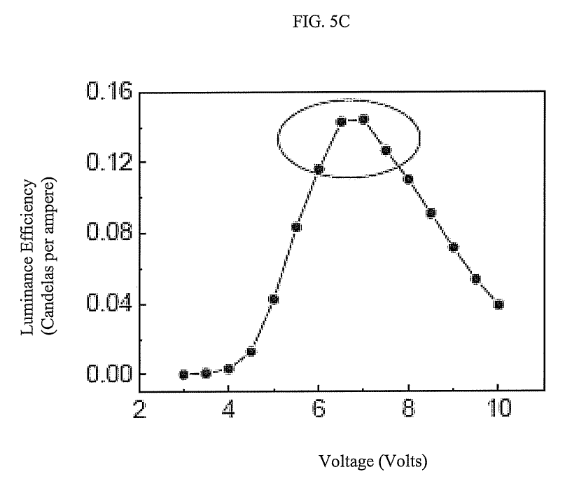

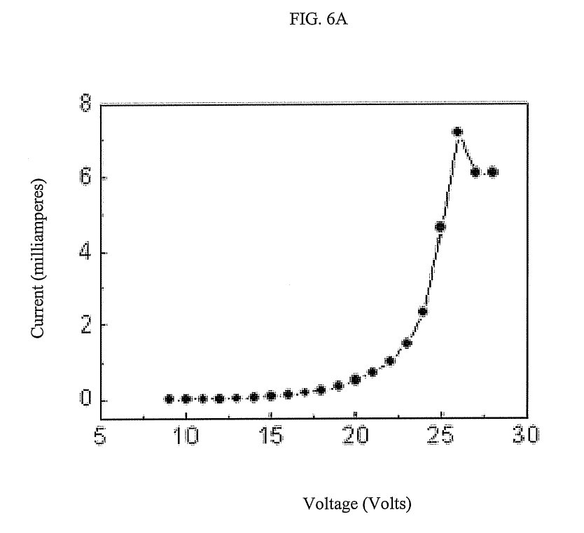

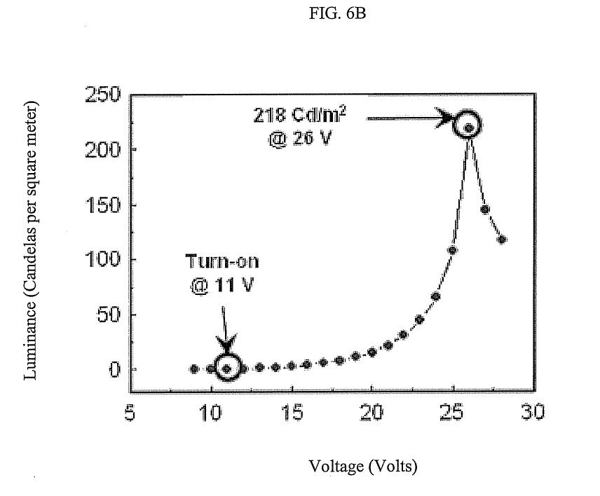

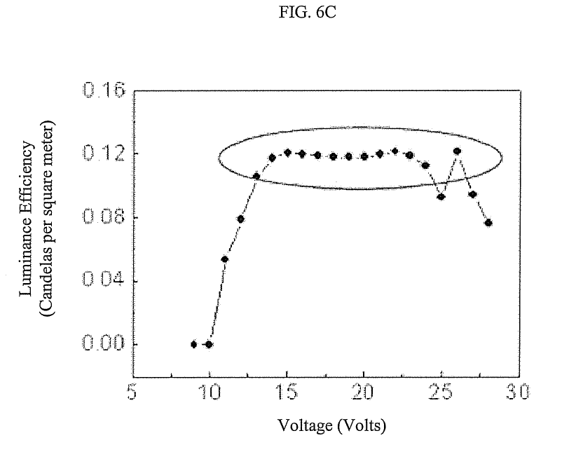

FIGS. 5A to 5C illustrate the physical properties of comparative examples, specifically current-voltage properties in FIG. 5A, luminance variation according to voltage in FIG. 5B, and efficiency variation according to voltage in FIG. 5C, of a single nanodot electroluminescent diode where one unit cell, which comprises a red quantum dot electroluminescent layer, is interposed between a lower electrode and an upper electrode. FIGS. 6A to 6C illustrate the physical properties of an exemplary multiple nanodot electroluminescent diode, specifically current-voltage properties in FIG. 6A, luminance variation according to voltage in FIG. 6B, and efficiency variation according to voltage in FIG. 6C, where two unit cells, each of which comprise a red quantum dot electroluminescent layer, are disposed and are in intimate contact in accordance with Example 1.

When a single unit cell is used, as shown in FIG. 5C, current to voltage efficiency is maximum value at about 7 V (volt). On the other hand, as shown in Example 1, the multiple nanodot electroluminescent diode can be driven with stable efficiency at a voltage of 15 V to 22 V, as shown in FIG. 6C. While not wanting to be bound by theory, this unexpected result is believed to be because a plurality of unit cells are disposed and in intimate contact, thus reducing leakage of current due to structural defects of the quantum dot electroluminescent layer thin film. In the case of the multiple nanodot electroluminescent diode, the current to voltage efficiency was 0.42 candelas per ampere (Cd/A), an increase of three times when compared with the single cell structure. Also, maximum luminance of the multiple structure was 620 candelas per square meter (Cd/m²), an increase of two times when compared with a maximum luminance of 265 Cd/m² of the single cell structure. Also, in the case of the multiple nanodot electroluminescent diode of Example 1, the current-voltage curve (IV curve) and voltage-to-luminance variation of the diode occur as shown in FIGS. 6A and 6B. Accordingly, it is noted that the multiple nanodot electrosuminescent diode provides excellent luminance and the diode is stable in contrast to the single unit cell structure.

### EXAMPLE 2

In Example 2, a diode was fabricated using two types of quantum dot electroluminescent layers, one red and one green. The diode according to Example 2 was fabricated by the same method as Example 1 except that in the second unit cell a green luminescing CdSe/ZnS core/shell nanocrystal (Evidot 630 nm absorbance, used as received commercially from Evident Technology, product name: Evidot green (CdSe/ZnS) at 0.3 weight percent (wt %) was used for the quantum dot electroluminescent layer.

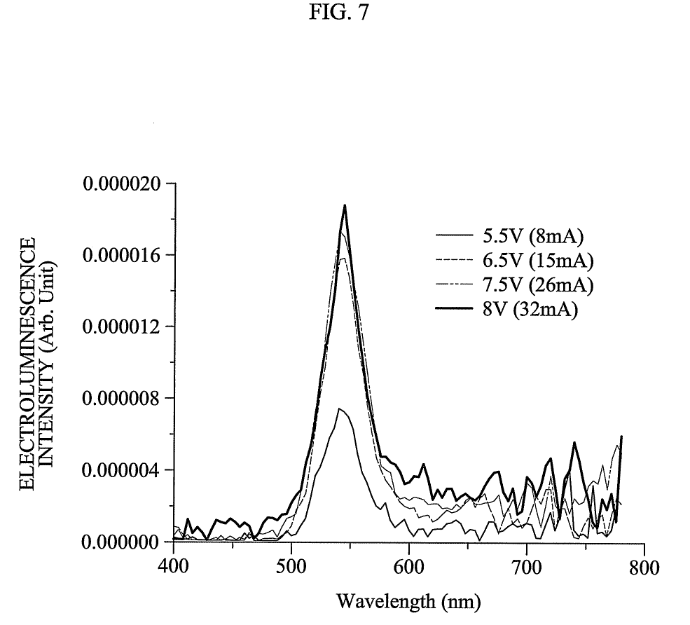

FIG. 7 illustrates the electroluminescence of a comparative example and is an electroluminescence (EL) spectrum illustrating a nanodot electroluminescent diode where a unit cell including a green quantum dot electroluminescent layer is interposed between a lower electrode and an upper electrode.

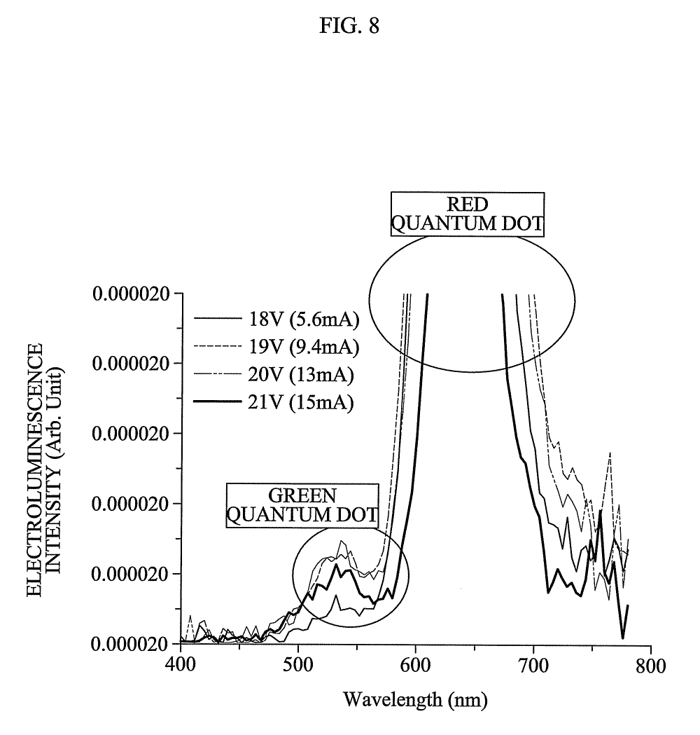

FIG. 8 is an EL spectrum illustrating a multiple nanodot electroluminescent diode where a unit cell including a red quantum dot electroluminescent layer and a unit cell including a green quantum dot electroluminescent layer are disposeddeposed and intimate contact in accordance with Example 2. As shown in FIG. 8, when red and green quantum dot electroluminescent layers were used, a green electroluminescent wavelength and a red electroluminescent wavelength were observed concurrently. It is thus understood from these results that electroluminescence of mixed colors, multi-colors, full color, or white electroluminescence can be obtained using multiple nanodot electroluminescent diodes.

As described above, the multiple nanodot electroluminescent diode according to an exemplary embodiment has greater thermal and mechanical stability than that of a multiple diode in a prior art OLED because the nanodot is used. Also demonstrated was constant, efficiency over a wide range of voltage, an increase in current to voltage efficiency, an increase in luminance, and superior reliability and stability of the diode, as compared with the diode of the comparative example where a single unit cell exists between the lower electrode and the upper electrode.

Furthermore, since the composite quantum dot electroluminescent layers of blue, red or green can be used within each unit cell, high resolution and composite colors can be obtained, in addition to white electroluminescence at high efficiency.

Although a few exemplary embodiments have been shown and described, the invention is not limited to the described exemplary embodiments. Instead, it would be appreciated by those skilled in the art that changes can be made to these exemplary embodiments without departing from the principles and spirit of the disclosure, the as described by the claims and their equivalents.

It will be understood that when an element is referred to as being “on” another element, it can be directly on the other element or intervening elements may be present therebetween. In contrast, when an element is referred to as being “disposed on”, “deposited on” or “formed on” another element, the elements are understood to be in at least partial contact with each other, unless otherwise specified.

The terminology used herein is for the purpose of describing particular embodiments only and is not intended to be limiting of the disclosed embodiments. As used herein, the singular forms “a”, “an” and “the” are intended to include the plural forms as well, unless the context clearly indicates otherwise. Thus the use of the terms a, an, etc. do not denote a limitation of quantity, but rather denote the presence of at least one of the referenced item. The use of the terms “first”, “second”, and the like do not imply any particular order but are included to identify individual elements. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements and the thicknesses of layers and regions are exaggerated for clarity.

This written description uses examples to aid description, including description of the best mode, and also to enable any person skilled in the art to practice that disclosed, including making and using any devices or systems and performing any incorporated methods. The patentable scope is defined by the claims, and can include other examples that occur to those skilled in the art. Such other examples are intended to be within the scope of the claims if they have elements that do not differ from the literal language of the claims, or if they include equivalent elements with insubstantial differences from the literal language of the claims.

In addition, many modifications can be made to adapt a particular situation or material to the disclosed teachings without departing from the essential scope thereof. Therefore, it is intended that the disclosure not be limited to the particular embodiment disclosed as the best mode contemplated, but that the disclosure will include all embodiments falling within the scope of the appended claims.

What is claimed is:

1. A multiple nanodot electroluminescent diode comprising:
a lower electrode;
an upper electrode that is opposedly disposed to the lower electrode; and
a plurality of unit cells interposed between the lower electrode and upper electrode; each unit cell comprising a quantum dot electroluminescent layer and an organic layer and/or an inorganic layer.

2. The multiple nanodot electroluminescent diode of claim 1, wherein the organic layer and/or the inorganic layer comprise a hole injection layer or a hole transport layer.

3. The multiple nanodot electroluminescent diode of claim 1, wherein the organic layer and/or the inorganic layer comprise an electron injection layer or an electron transport layer.

4. The multiple nanodot electroluminescent diode of claim 1, wherein the unit cells further include an electrode layer.

5. The multiple nanodot electroluminescent diode of claim 1, wherein the unit cells comprise a hole transport layer, a quantum dot electroluminescent layer, and an electron transport layer.

6. The multiple nanodot electroluminescent diode of claim 1, wherein the unit cells comprise a hole transporting layer, a quantum dot electroluminescent layer, an electron transport layer, and an electrode layer.

7. The multiple nanodot electroluminescent diode of claim 1, wherein the unit cells comprise a hole injection layer, a hole transport layer, a quantum dot electroluminescent layer, and an electron transport layer.

8. The multiple nanodot electroluminescent diode of claim 1, wherein the quantum dot electroluminescent layer comprises a group II-VI compound, the group II-VI compound being a binary compound that comprises CdSe, CdTe, ZnS, ZnSe, or ZnTe, a ternary compound that comprises CdSeS, CdSeTe, CdSTe, ZnSeS, ZnSeTe, ZnSTe, CdZnS, CdZnSe, or CdZnTe, or a quaternary compound that comprises CdZnSeS, CdZnSeTe, CdZnSTe, CdHgSeS, CdHgSeTe, CdHgSTe, HgZnSeS, HgZnSeTe, or HgZnSTe;
a group III-V compound; the group III-V compound being a binary compound that comprises GaN, GaP, GaAs, GaSb, InP, InAs, or InSb, a ternary compound that comprises GaNP, GaNAs, GaNSb, GaPAs, GaPSbInNP, InNAs, InNSb, InPAs, InPSb, or GaAlNP, or a quaternary compound that comprises GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, or InAlPSb;
a group IV-VI compound the group IV-VI compound being a binary compound that comprises PbS, PbSe, and PbTe, a ternary compound that comprises PbSeS, PbSeTe, PbSTe, SnPbS, SnPbSe, and SnPbTe, or a quarternary compound that comprises SnPbSSe, SnPbSeTe, or SnPbSTe;
a group VI compound the group VI compound being a single element compound that comprises Si or Ge; or a binary compound including SiC or SiGe; or a combination comprising at least one of the foregoing materials.

9. The multiple nanodot electroluminescent diode of claim 1, wherein the quantum dot electroluminescent layer included within each unit cell luminesces in the same color for each unit cell.

10. The multiple nanodot electroluminescent diode of claim 1, wherein the quantum dot electroluminescent layer included within each unit cell luminesces in a different color for each unit cell.

11. The multiple nanodot electroluminescent diode of claim 1, wherein the quantum dot electroluminescent layer included in each unit cell is disposed in the same configuration as that of an organic layer and/or an inorganic layer.

12. The multiple nanodot electroluminescent diode of claim 1, wherein the quantum dot electroluminescent layer included in each unit cell is disposed in a configuration different from that of an organic layer and/or an inorganic layer.

13. A method for fabricating a multiple nanodot electroluminescent diode using a wet method, the nanodot electroluminescent diode comprising a lower electrode, an upper electrode, and a plurality of unit cells interposed between the electrodes, the method comprising:
forming the unit cells by sequentially disposing the lower electrode, the quantum dot electroluminescent layer, and an organic layer and/or an inorganic layer by using a solution coating method selected from the group consisting of spin coating, a sol-gel method, deep coating, casting, printing, and spraying, and a combination comprising at least one of the foregoing methods;
successively depositing the unit cells using the solution coating method; and
forming the upper electrode on the uppermost layer of the last unit cell.

14. The method of claim 13, wherein the organic layer and/or the inorganic layer of the unit cells include a hole injection layer and/or a hole transport layer.

15. The method of claim 13, wherein the organic layer and/or the inorganic layer of the unit cells comprise an electron injection layer and an electron transport layer.

16. The method of claim 13, wherein the unit cells further comprise an electrode layer.

17. The method of any one of claim 13 to claim 15, wherein the electron injection layer or the electron transport layer is formed by a dry coating method selected from the group consisting of thermal deposition, e-beam deposition, sputtering, and vacuum deposition, and a combination comprising at least one of the foregoing methods.
